(19) United States
(12) Patent Application Publication
(10) Pub. No.: US 2018/0316580 A1
(43) Pub. Date: Nov. 1, 2018

(54) MEASUREMENT EVALUATION DEVICE

(71) Applicant: Sciencematters AG, Zurich (CH)

(72) Inventor: Lawrence Rajendran, Zurich (CH)

(21) Appl. No.: 15/771,594

(22) PCT Filed: Oct. 27, 2015
(86) PCT No.: PCT/CH2015/000156

§ 371 Date: Apr. 27, 2018

(51) Int. Cl. H04L 12/26; G06F 9/50

(52) U.S. Cl. CPC H04L 43/04; H04L 43/08; G06F 9/5011; G06F 9/5027

(57) ABSTRACT

A device (1) for evaluating a quality of measurements, the device (1) comprising a data store storing a set of n network nodes Nᵢ, wherein said nodes store measurement data. The data store further comprises a set of l network links Lᵢⱼ, wherein each of the network links Lᵢⱼ connects one network node Ni with at least one network node Nⱼ. The device (1) further comprises a quality evaluation unit (12) for calculating said quality, which quality evaluation unit (12) is adapted and structured to calculate a quality score Q as a function of said links Lᵢⱼ.

### TECHNICAL FIELD

The present invention relates to a device for evaluating a quality of measurements and a method for evaluating measurements with the device.

### BACKGROUND ART

To verify a distinct measurement result, large amounts of measurement data might be collected which data needs to be analyzed and archived.

Regarding the state of the art, current device architectures for evaluating measurement data are simple storage devices, which store the data in a set of measurement data in a database. If large amounts of measurement data are collected, it can become very difficult to analyze the sets of measurement data and to verify, which measurement data is relevant in view of the whole set of measurement data, e.g. which data is confirming or contradicting a distinct measurement result of the set. The verification can become even more complex if multiple sources add measurement data to such a storage device.

### DISCLOSURE OF THE INVENTION

The problem to be solved by the present invention is therefore to provide a device that enables the evaluation of sets of measurement data.

This problem is solved by a device for evaluating a quality of measurements, the device comprising a data store storing a set of n network nodes wherein said nodes store measurement data. Optionally, each node is attributed to at least one of a number s of subsets Sₖ. In addition to the data store, the device preferably comprises a server to connect the device with a public network and to exchange data therewith, such that users of the network can access the device and generate said nodes Nᵢ, Nⱼ.

The subsets Sₖ are preferably each assigned to a source Uₖ, which source Uₖ is preferably a user of the device, a group of users of the device, or a specific measurement equipment that contributes to the measurement data that is stored in the nodes Nᵢ, Nⱼ of the subset Sₖ.

If subsets are used, each subset Sₖ can contain only one single node Nᵢ or can contain more than one node Nᵢ, Nⱼ.

The data store is further comprising a set of l network links Lᵢⱼ, wherein each of the network links Lᵢⱼ connects one network node Nᵢ with at least one network node Nⱼ, wherein each link Lᵢⱼ comprises a linking value vᵢⱼ indicative of a correspondence between said nodes Nᵢ and Nⱼ. Preferably, the linking value vᵢⱼ is larger for a higher correspondence between the nodes Nᵢ and Nⱼ as compared to the linking value vᵢⱼ for a lower correspondence between said nodes Nᵢ and Nⱼ. The correspondence between the two nodes Nᵢ and Nⱼ can be dynamic over time, such that the linking value vᵢⱼ can change over time. The linking values vᵢⱼ are preferably scalar values, but can also be vector values in a node coordinate system. The nodes Nᵢ, Nⱼ and links Lᵢⱼ are preferably programmed within a software setting of the data store.

In addition, the device comprises a quality evaluation unit for calculating the quality, which quality evaluation unit is adapted and structured to calculate a quality score Q of measurements as a function of the links Lᵢⱼ. The quality evaluation unit is preferably linked to the data store. The quality score Q can be calculated as Q_{Sk} for a subset Sₖ of the s subsets Sₖ and/or as Q_{Ni} for a node Nᵢ of the set of nodes Nᵢ, Nⱼ, in both cases as a function of the links Lᵢⱼ. The quality factor Q is preferably a scalar value.

In a further aspect of the invention, the device comprises, in addition, a resource allocation unit for allocating computing units, bandwidth or storage resources for processing the nodes as a function of the quality score Q. The resource allocation unit is preferably connected to the data store and the storage and computing units of the device and receives information regarding the quality scores Q of the individual nodes Nᵢ or subsets Sₖ from the quality evaluation unit.

The resource allocation unit preferably selects the number of resources (such as a number of computing units, a processing or networking bandwidth or a storage performance) to be used for processing a given node Nᵢ, Nⱼ or a subset of the nodes as a function of the quality score Q, in particular of the quality score Q_{Ni} of the measurement data of a node Nᵢ and/or of the quality score Q_{Sk} of the measurement data of a subset Sₖ.

Preferably, the device comprises a plurality of computing units, wherein the resource allocation unit is adapted and structured to allocate a number z of said computing units for processing a given node. The associated number z depends on the quality score Q, in particular on the quality score Q_{Ni} of the measurement data of a node Nᵢ and/or on the quality score Q_{Sk} of the measurement data of a subset Sₖ.

The computing units form a logical part of the device. They may be centralized or decentralized.

Allocating the number z of computing units preferably relates to assigning a certain number of central processing units (CPUs) for processing the particular node. Processing the nodes e.g. relates to the evaluation of the quality of the measurement data, in particular by calculating the quality score Q. In addition, the processing of the node can comprise the assignment of the measurement data to a node Nᵢ in a set of nodes Nᵢ, Nⱼ and/or the attributing of subsets Sₖ to the nodes Nᵢ, Nⱼ. Data processing can further comprise the connecting of the nodes Nᵢ, Nⱼ by links Lᵢⱼ, and further indicating the correspondence between the nodes Nᵢ and Nⱼ to assign a linking value vᵢⱼ to each link Lᵢⱼ. Data processing can also comprise the retrieval and/or the displaying of a node on a display device.

In addition, the resource allocation unit of a preferred device is adapted and structured to allocate bandwidth resources to the node, depending on the quality score Q. In particular, the allocation of the bandwidth resources for a node Nᵢ is dependent on the quality score Q_{Ni} of the node Nᵢ and/or on the quality score Q_{Sk} of the subset Sₖ that the node Nᵢ is attributed to. Bandwidth resources preferably relate to the amount of data that is exchanged in a given time, e.g. for retrieving nodes or transmitting measurement data in nodes, e.g. between the computing units and storage resources or between the device and remote objects.

A preferred embodiment of the device comprises a plurality of storage resources, in particular storage resources with different performance. The resource allocation unit is adapted and structured to select the storage resources for storing a given node depending on the quality score Q. In particular, the selection of the storage resources is dependent on the quality score Q_{Ni} of the node Nᵢ and/or on the quality score Q_{Sk} of a subset Sₖ that the node Nᵢ is attributed to.

Storage resources preferably refer to hardware storage that forms a logical part of the device. Storage resources can be centralized or decentralized.

As mentioned before, the quality evaluation unit for calculating the quality of measurements is adapted and structured to calculate the quality score Q as a function of the links Lᵢⱼ.

As already indicated, the nodes can belong to certain subsets Sₖ of nodes, which can e.g. describe the source, e.g. an authorship of the data, of a node or a measurement equipment used to generate the data in the node. The number of said subsets is in the following designated as s. In that case, the data store is advantageously structured and designed to store, for each of said nodes, information indicative of at least one subset Sₖ of nodes that a node belongs to. Further, the evaluation unit is adapted and structured for calculating a subset quality score Q_{Sk} at least for said subset Sₖ as a function of said links Lᵢⱼ. This subset quality score Q_{Sk} forms a specific embodiment of said quality score Q and describes the quality of the subset Sₖ.

As mentioned, a subset Sₖ can comprise no node, a single node or several nodes.

Alternatively or in addition thereto, the quality evaluation unit (12) is adapted and structured for calculating a node quality score Q_{Ni} for at least one node Nᵢ of said nodes as a function of said links Lᵢⱼ. This node quality score Q_{Ni} forms another specific embodiment of said quality score Q, and it describes the quality of the node Nᵢ.

In other words, the quality score Q can be calculated for a single node Nᵢ of a set of nodes Nᵢ, Nⱼ or for a subset Sₖ of the nodes Nᵢ, Nⱼ.

The links Lᵢⱼ between the nodes Nᵢ, Nⱼ can comprise directional links indicating that a succeeding node Nⱼ depends on a seeding node Nᵢ. For example, such a directed link can represent the relationship between two measurements, wherein measurement data stored in the seeding node Nᵢ led to a follow-up measurement, which data is stored in succeeding node Nⱼ. In a further example, the data stored in a succeeding node Nⱼ might be based on results or methods used in a measurement which data is attributed to the seeding node Nᵢ, and thus causing a directed relationship. The quality score Qᵢ of at least one node Nᵢ of the set of nodes Nᵢ, Nⱼ in such a network with directional Links Lᵢⱼ is impacted by a seeding potential of the particular node Nᵢ, which is quantitatively defined by a node seeding potential NSPᵢ of the node Nᵢ given by a formula (I) as

NSPᵢ=|Cᵢ| (I),

wherein Cᵢ refers to a set of nodes containing all nodes Nⱼ depending directly or indirectly on the node Nᵢ to which they are linked via the directional links Lᵢⱼ. The operator | . . . | designates the cardinality of the set Cᵢ, i.e. the number of elements Nⱼ in the set. The quality score Q_{Ni} of the nodes Nᵢ is preferably impacted by the NSPᵢ of the node Nᵢ.

The node seeding potential NSPᵢ is an example for a node quality score Q_{Ni}.

To evaluate the seeding potential not only for a single node Nᵢ, but also for a subset of nodes Nᵢ, Nⱼ, the quality evaluation unit is preferably structured to further calculate a source seeding potential SSPₖ of the subset Sₖ as a function of the node seeding potential NSPᵢ of the nodes Nᵢ contained in the subset Sₖ, given by a formula (II) as

$${SSP}_{k} = {\sum }_{{N}_{i} i n {S}_{k}} {NSP}_{i} . \qquad ( II )$$

The source seeding potential SSPₖ is an example for a source quality score Q_{Sk}.

More generally, the source quality score Q_{Sk} of the subset Sₖ is preferably a function of the source seeding potential SSPₖ. Thereby, the quality of measurements from a specific source Uₖ, which contributed the measurement data in the nodes Nᵢ, Nⱼ of the subset Sₖ, can be evaluated, e.g. a first source U₁ referring to a first subset S₁ can be evaluated in comparison with a second source U₂, referring to a second subset S₂, by comparing the quality scores Q_{S1} and Q_{S2} of each subset S₁, S₂.

A further embodiment of the present invention assesses the impact of the linking values vᵢⱼ on the quality score Q for a particular node Nᵢ of a set of nodes Nᵢ, Nⱼ. Therefore, the quality evaluation unit is adapted and structured to evaluate a node bridging potential NBPᵢ of at least one node Nᵢ of the set of nodes Nᵢ, Nⱼ. The node bridging potential NBPᵢ is given by formula (III) as

NBPᵢ=P(Mᵢ)−P(M′₁) (III)

with M₁ being a set of links Lₘ containing all links Lᵢⱼ of the set of links Lᵢⱼ that connect the nodes Nⱼ of the set of nodes Nᵢ, Nⱼ directly or indirectly to said node Nᵢ, and with being said set Mᵢ of links Lₘ without the links Lᵢⱼ to said node Nᵢ. P is a function of a set X of links given by formula (IV) as

$$P ( X ) = {\sum }_{links {L}_{ij} of the set X} {v}_{ij} . \qquad ( IV )$$

The NBPᵢ assesses not only the impact of the linking values vᵢⱼ, but also provides an indication of the bridging potential of an individual node Nᵢ, viz. it correlates to a number of branches the node Nᵢ is linking with each other and increases with an increasing number thereof.

The node seeding potential NBPᵢ is a further example for a node quality score Q_{Ni}.

To account for the bridging potential of individual sources Uₖ or, more generally, of subsets Sₖ, the quality evaluation unit is preferably adapted and structured to calculate the quality score Q_{Sk} as a function of the source bridging potential SBPₖ of a subset Sₖ of the s subsets Sₖ. The source bridging potential SBPₖ is thereby given by formula (V) as

$${SBP}_{k} = {\sum }_{{k}^{′} = 1 , … , s without k} ( P ( {T}_{k} ) - P ( {T}_{{k}^{′}}^{′} ) ) , \qquad ( V )$$

with Tₖ being a set containing all links Lᵢⱼ of the set of links Lᵢⱼ that connect nodes Nᵢ of the set of nodes Nᵢ, Nⱼ directly or indirectly to at least one node Nᵢ in said subset Sₖ. T′_{k′} contains the links of said set Tₖ, but without the links Lᵢⱼ directly connected to at least one node Nᵢ in said subset Sₖ, and wherein the links Lᵢⱼ of T′_{k′} connect directly or indirectly to nodes Nᵢ of the subset S′_{k′}. P is the function of a set X of links Lᵢⱼ given by formula (VI) as

$$P ( X ) = {\sum }_{links {L}_{ij} of the set X} {v}_{ij} . \qquad ( VI )$$

The source bridging potential SBPₖ accounts for the impact the individual subsets Sₖ have on the quality score Q and reflects the bridging potential of the individual subsets Sₖ and therefore the individual sources Uₖ within the set of linked nodes Nᵢ, Nⱼ.

The source bridging potential SBPₖ is a further example for a source quality score Q_{Sk}.

The quality evaluation unit is preferably not only adapted and structured to calculate the quality score Q, but also to evaluate a maximal node quality score Q_{Ni,max} from a set of quality scores comprising a first node quality score Q_{N1} of a first node N₁ and a second node quality score Q_{N2} of a second node N₂. In addition, the quality evaluation unit can further evaluate the maximal subset quality score Q_{Sk,max} from a subset Sₖ of s subsets Sₖ comprising a first subset quality score Q_{S1} of a first subset S₁ and a second subset quality score Q_{S2} of a second subset S₂. Furthermore the quality evaluation unit can also calculate a quality score of a particular node Nᵢ in a particular subset Sₖ, e.g. by adding or multiplying the node quality score Q_{Ni} of the node Nᵢ of the set Sₖ with the subset quality score Q_{Sk} of the set Sₖ.

Preferably, the quality evaluation unit is further structured to calculate the quality score Q as a combination of one or more of the node seeding potential NSP, the source seeding potential SSP, the node bridging potential NBP, and/or the source bridging potential SBP.

More generally, the quality evaluation unit is further structured to calculate at least a first quality score Q of a first node or subset and a second quality score Q of a second node or subset, and to evaluate a node or subset Sₘₐₓ with a highest quality score Qₘₐₓ.

In a preferred embodiment of the invention, the device for evaluating a quality of measurements is further configured to return a quality score Q of a node Nᵢ comprising measurement data and/or of the subset Sₖ comprising the node Nᵢ to the source of the measurement data, e.g. to users of a public network or to measurement equipment which collected the data.

A further aspect of the invention relates to a method for evaluating the measurements using the device for evaluating a quality of measurements. The method comprises the steps of storing the measurement data in the nodes Nᵢ, Nⱼ and storing the links Lᵢⱼ that connect one network node Nᵢ with a network node Nⱼ. The quality score Q is further calculated for evaluating the quality of the measurement data. Preferably, the source quality score Q_{Sk} of the subset Sₖ of the nodes Nᵢ, Nⱼ is calculated as a function of the links Lᵢⱼ, for evaluating the quality of the measurement data in the subset Sₖ. Also, the node quality score Q_{Ni} of the node Nᵢ of the set of nodes Nᵢ, Nⱼ is preferably calculated as a function of the links Lᵢⱼ, for evaluating the quality of the measurement data in the particular node Nᵢ. A preferred method comprises the further steps of executing a number of measurements, by means of several sources Uₖ, and storing measurement data from the sources Uₖ in the nodes Nᵢ, Nⱼ, wherein the subsets Sₖ correspond to the sources Uₖ, and wherein the nodes Nᵢ, Nⱼ are linked by the network links Lᵢⱼ.

A preferred step of the method is to send the quality score Q_{Ni} of the nodes of the subset and the quality score Q_{Sk} of the subset itself to the source of the measurement data attributed to the nodes of the subset after the evaluation of the measurement data.

In a preferred embodiment of the invention, the source or, in particular, the user corresponds to an author of a scientific observation, and the scientific observation corresponds to the measurement data stored in a node of the set. An author making several such scientific observations can store each scientific observation and related information in a new node of the set and link it to at least one of the author's earlier observations by confirmatory or contradictory indications of the links, thus creating a storyline of his observations.

Other advantageous embodiments are listed in the dependent claims as well as in the description below.

As used herein, the term “contain” is used in its limiting sense, i.e. a “set containing elements” is a set containing exactly and only said elements.

It is understood that the various embodiments and preferences as provided in this specification may be combined at will.

### BRIEF DESCRIPTION OF THE DRAWINGS

Embodiments of the present invention, aspect and advantages will become apparent from the following detailed description thereof. Such description makes reference to the annexed drawings, wherein the figures show:

FIG. 1 a schematic of an architecture of the device for evaluating a quality of measurements with its peripherals according to an embodiment of the invention,

FIG. 2a a semantic network of a set of nets work nodes Nᵢ, Nⱼ linked by network links Lᵢⱼ, wherein the links Lᵢⱼ are directional links indicating that node Nⱼ is depending on node Nᵢ according to an embodiment of the invention,

FIG. 2b a semantic network of a set of network nodes Nᵢ, Nⱼ, wherein links Lᵢⱼ connecting the node Nᵢ with the node Nⱼ comprise linking values vᵢⱼ indicating a correspondence between the nodes Nᵢ and Nⱼ according to an embodiment of the invention, and

FIG. 2c a semantic network of the correspondence between different subsets Sₖ according to an embodiment of the invention.

### MODES FOR CARRYING OUT THE INVENTION

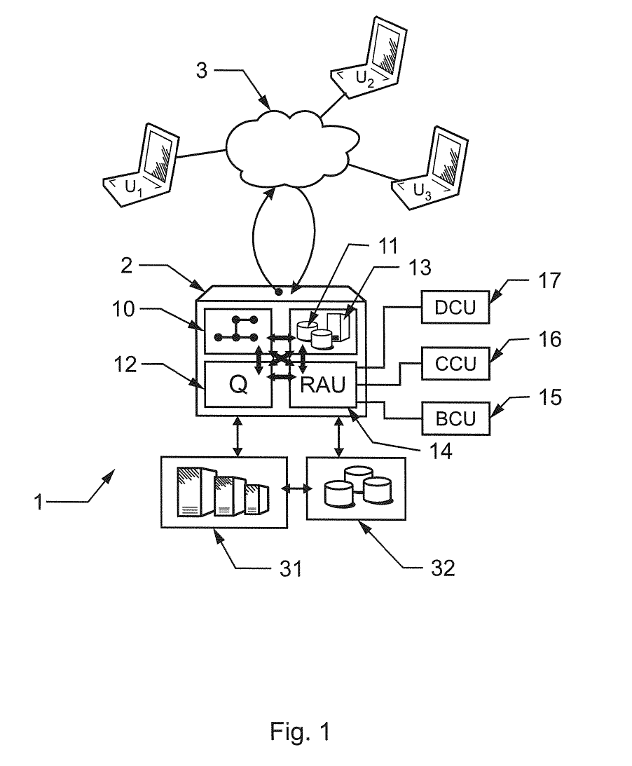

FIG. 1 shows a device architecture of a preferred embodiment of the invention. The device 1 can be formed by one or more physical or virtual servers and databases and a data network linking the same.

In the example shown, there is a primary server 2 containing a primary database 11 and a primary set of computing units 13. In addition, device 1 of the embodiment of FIG. 1 comprises secondary database 32 and secondary computing units 31, e.g. installed at locations remote from primary server 2.

Device 1 maintains a network 10 of nodes, wherein each measurement data (or other type of data) added to the network 10 generates a new entry in the network 10 as a new network node Nᵢ in a set of n nodes Nᵢ.

Network 10 is stored in the databases 11, 32, which together form the data store of the device.

The data store stores the measurement data, nodes Nᵢⱼ, links Lᵢⱼ and linking values vᵢⱼ. The computing units 13, 31 process the same.

The device 1 is typically connected to a public network 3, such that users Uₖ of this network, e.g. the three users U₁, U₂, and U₃ of FIG. 1, can store their measurement data as well as other types of observations as nodes in the data store of device 1. All nodes Nᵢ originating from one user Uₖ out of the set of n nodes Nᵢ, Nⱼ are attributed to a subset Sₖ, e.g. to S₁, S₂, or S₃ for users U₁, U₂, and U₃. In other words, the nodes are attributed to several subsets, and these subsets can e.g. represent the contributing users of the system.

The subset(s) that each node belongs to are also stored in the data store of device 1.

The data store further stores a set of network links Lᵢⱼ, wherein each of the network links Lᵢⱼ connects one network node Nⱼ with at least one network node Nⱼ. Each link Lᵢⱼ comprises a linking value v₁₃ being indicative of a correspondence between the nodes Nᵢ and Nⱼ.

Typically, there exist links between only some of the nodes in the network, i.e. one node is typically connected to only part of the other nodes. Some nodes may not have any links at all.

In addition to the data store, the device 1 comprises a quality evaluation unit 12, for calculating a quality of the measurements. The quality evaluation unit 12 is adapted and structured to calculate a “quality score Q” as a function of the links Lᵢⱼ. The quality evaluation unit is preferably implemented as a software for the network 10. It can e.g. be running on the processing units 13 for accessing the network and for processing the calculation of the quality score.

In addition, the device 1 comprises a resource allocation unit (RAU) 14, which can e.g. also be a software running on the processing units 13.

The resource allocation unit 14 can allocate bandwidth resources within the device 1 by means of a bandwidth control unit (BCU) 15. Allocating bandwidth resources to a node Nᵢ or to a subset Sₖ can include the reservation of a certain bandwidth for data transfer to or from the node Nᵢ or subset Sₖ, e.g. for editing, displaying or downloading the data stored in the particular node Nᵢ or in a node Nᵢ of the subset Sₖ. The resource allocation unit 14 allocates the bandwidth resources for a particular node Nᵢ or a subset Sₖ depending on its quality score Q.

The resource allocation unit 14 can further allocate a number z of said computing units 13, 31 for processing a given node or subset of nodes by means of a computing control unit (CCU) 16. In general, the resource allocation unit 14 allocates the computing resources for a particular node Nᵢ or a subset Sₖ depending on its quality score Q.

The resource allocation unit 14 can further select the database(s) or (in more general terms) the storage resources to be used for storing a given node by means of a database control unit (DCU) 17. The resource allocation unit 14 allocates the storage resources for a particular node Nᵢ or a subset Sₖ depending on its quality score Q.

As mentioned, the computing units 13, 31, databases 11, 32 and bandwidth resources are allocated for a particular node Nᵢ or a subset Sₖ depending on their quality score Q. Nodes Nᵢ with a high quality score Q_{Ni} and subsets Sₖ with a high quality score Q_{Sk} can benefit from more and better resources, e.g. faster exchange of data to the particular storage resource where the data measurements attributed to the particular node Nᵢ or subset Sₖ are stored, or allocation of more computing units 13, 31 or bandwidth for faster processing of the data.

For example, a higher number z of computing units 13, 31, a larger amount of bandwidth and/or a faster storage resources 11, 32 can be provided by the resource allocation unit 14 for a node if the quality score Q exceeds a certain threshold or if a first quality score Q₁ exceeds a second quality score Q₂.

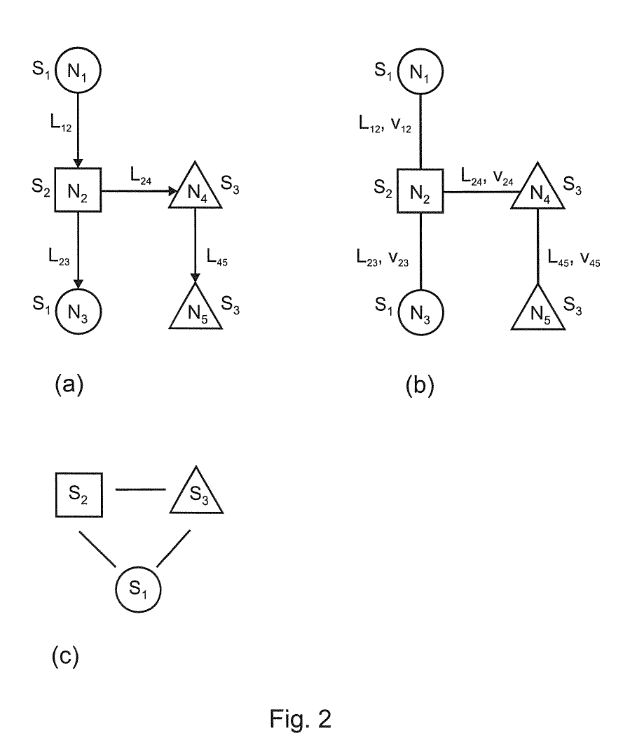

FIG. 2 shows an example of an evaluation of the quality of the nodes, in particular of the measurement data in the nodes, for a simple case comprising three subsets S₁, S₂, and S₃. FIGS. 2a and 2b show each the same topology of the network 10 with a set of network nodes Nᵢ, N₂, N₃, N₄, and N₅, wherein each node is attributed to one subset S₁, S₂, or S₃ such that S₁{N₁, N₃}, S₂={N₂}, and S₃={N₄, N₅}. The affiliation is illustrated in the figure, such that nodes of the subset S₁ are illustrated as circles, nodes of subset S₂ are illustrated as squares, and nodes of subset S₃ are illustrated as triangles.

In the preferred embodiment of the invention shown in FIG. 2a, the links Lᵢⱼ are directional links indicating that a node Nᵢ depends on a node Nⱼ, which linking direction is indicated by arrows in FIG. 2a. The link L₁₂ linking node N₁ and node N₂ is directed from node N₁ to node N₂, link L₂₃ is directed from node N₂ to node N₃, link L₂₄ is directed from node N₂ to node N₄, and link L₄₅ is directed from node N₄ to node N₅. The direction of the links Lᵢⱼ refers to the relationship between the linked nodes Nᵢ and Nⱼ. A directed link can have different effects on the two nodes that it connects.

For example, if the measurement data stored in one node Nᵢ inspired a user of the device to collect the measurement data in node Nⱼ, node Nⱼ is considered to be a successor node of a seeding node Nᵢ and thus the link between the two is directed from seeding node Nᵢ to successor node Nⱼ. Such a relationship can also relate to the use of a same method or a same probing sample for an experiment collecting measurement data comprised in nodes Nᵢ and Nⱼ.

For each node N₁, N₂, N₃, N₄, and N₅ the quality evaluation unit 12 can calculate a node quality score Q_{N1}, Q_{N2}, Q_{N3}, Q_{N4}, and Q_{N5} respectively and/or for each subset S₁, S₂, and S₃, a respective subset quality score Q_{S1}, Q_{S2}, and Q_{S3} as a function of the links Lᵢⱼ.

An example of a node quality score is the node seeding potential. A node seeding potential NSPᵢ is an indicator on how many successor nodes Nⱼ are directly or indirectly succeeding from a seeding node Nᵢ. The quality evaluation unit is adapted and structured to calculate this node seeding potential NSPᵢ for a node Nᵢ by calculating the cardinality of the set of succeeding nodes Nⱼ of a node Nᵢ with the formula (I)

NSP₁=|Cᵢ|, (I)

wherein Cᵢ is a set of nodes containing all nodes Nⱼ depending directly or indirectly on the seeding node Nᵢ. Therefore, it follows for the nodes seeding potentials NSPᵢ of this example:

C₁={N₂,N₃,N₄,N₅}⇒NSP₁=|C₁|=4

C₂={N₃,N₄,N₅}⇒NSP₂=|C₂|=3

C₃={ }⇒NSP₃=|C₃|=0

C₁={N₅}⇒NSP₄=|C₄|=1

C₅={ }⇒NSP₅=|C₅|=0

According to the calculations, node N₁ has the highest node seeding potential NSP. A higher seeding potential NSPᵢ of a node Nᵢ indicates that a higher number of directly and indirectly succeeding nodes Nⱼ that are related to the node Nᵢ.

To assess the impact of a subset Sₖ of nodes Nᵢ on the quality score Qᵢ, the quality evaluation unit 3 is structured to calculate a source seeding potential SSP of each set Sₖ. The source seeding potential SSP is an example of a subset quality score, and it can be calculated as a function of formula (II)

$${SSP}_{k} = {\sum }_{{N}_{i} i n {S}_{k}} {NSP}_{i} . \qquad ( II )$$

For each of the example subsets S₁, S₂, and S₃, the SSPₖ can therefore be calculated as following:

$${SSP}_{1} = {\sum }_{{N}_{i} i n {S}_{1}} {NSP}_{i} = {NSP}_{1} + {NSP}_{3} = 4$$

$${SSP}_{2} = {\sum }_{{N}_{i} i n {S}_{2}} {NSP}_{i} = {NSP}_{2} = 3$$

$${SSP}_{3} = {\sum }_{{N}_{i} i n {S}_{3}} {NSP}_{i} = {NSP}_{4} + {NSP}_{5} = 1$$

Subset S₁ has the highest source seeding potential. A higher source seeding potential SSPₖ of a subset Sₖ indicates that a higher number of directly and indirectly succeeding nodes Nⱼ are related to a node Nᵢ of a subset, but in addition also assesses if a subset comprises multiple seeding nodes Nᵢ which relate to succeeding nodes Nⱼ. The source seeding potential SSPₖ of a subset impacts the calculation of the source quality score Q_{Sk} of the respective subset, i.e. the quality score is advantageously a function of the source seeding potential of a subset.

In a further embodiment of the invention shown in FIG. 2b, each link Lᵢⱼ comprises a linking value vᵢⱼ that is indicative of a correspondence between the nodes Nᵢ and Nⱼ. In contrast to the embodiment of FIG. 2a, the links Lᵢⱼ are non-directional, i.e. each link has typically the same effects on both nodes that it is connected to.

Node N₁ is linked via link L₁₂ to node N₂, wherein the link L₁₂ comprises a value v₁₂. The node N₂ is linked to N₃ via link L₂₃ with value v₂₃ and to node N₄ via link L₂₄ with value v₂₄. The node N₄ is again linked to node N₅ via link L₄₅ with value v₄₅. Preferably, such a correspondence refers to a confirmatory or contradictory indication between the node Nᵢ and Nⱼ. For example, if the measurement data stored in Nᵢ is confirmed by a further measurement data stored in Nⱼ, the correspondence between the nodes Nᵢ and Nⱼ could be positive and therefore a linking value vᵢⱼ=(+1) could be assigned. In a further example, if the measurement data stored in Nᵢ is contradictory to the measurement data stored in Nⱼ, the correspondence between the nodes Nᵢ and Nⱼ would be negative and a linking value vᵢⱼ=(−1) would be assigned. In further examples, the linking values vᵢⱼ could be further assessed by a level of agreement or disagreement of the measurement data corresponding to the nodes Nᵢ and Nⱼ, which level would be expressed by linking values vᵢⱼ>(+1) for a high level of agreement and linking values vᵢⱼ<(−1) for a high level of disagreement. In addition, the linking value vᵢⱼ of a link Lᵢⱼ between the node Nᵢ and the node Nⱼ can also be neutral, taking on a value of vᵢⱼ=0, to indicate that there is a relationship between node Nᵢ and node Nⱼ, but that neither a confirmation nor a contraction has been found. A higher linking value vᵢⱼ is defined by having a higher numerical value than a lower linking value vᵢⱼ. Hence, in this case the linking values are advantageously scalars.

To evaluate the correspondence of the particular node Nᵢ with the nodes of the set of nodes Nᵢ, Nⱼ, the quality evaluation unit is adapted and structured to calculate a node bridging potential NBPᵢ of the node Nᵢ, wherein the node bridging potential NBPᵢ is given by formula (III) as

NBPᵢ=P(Mᵢ)−P(M′ᵢ) (III)

with Mᵢ being a set of links Lₘ containing all links Lᵢⱼ that connect the nodes Nⱼ directly or indirectly to said node Nᵢ. M′ᵢ is said set Mᵢ of links Lₘ without the links Lᵢⱼ linked directly to said node Nᵢ. P is a function of a set X of links given by formula (IV)

$$P ( X ) = {\sum }_{links {L}_{ij} of the set X} {v}_{ij} . \qquad ( IV )$$

For the present example, the linking values vᵢⱼ are assumed to have the values [v₁₂, v₂₃, v₂₄, v₄₅] =[1, 1, 1, 1]. The node bridging potentials NBPᵢ for the nodes N₁, N₂, N₃, N₄, and N₅ are then calculated as following:

NBP₁=P(M₁)−P(M′₁)=4−3=1

with M₁={L₁₂, L₂₃, L₂₄, L₄₅} and P(M₁)=4
M′₁={L₂₃, L₂₄, L₄₅} and P(M₁)=3,
and

NBP₂=P(M₂)−P(M′₂)=4−1=3

with M₂={L₁₂, L₂₃, L₂₄, L₄₅} and P(M₂)=4
M′₂={L₄₅} and P(M₂)=1,
and

NBP₃=P(M₃)−P(M′₃)=4−3=1

with M₃={L₁₂, L₂₃, L,₂₄, L₄₅} and P(M₃)=4
M′₃={L₁₂, L,₂₄, L₄₅} and P(M₃)=3,
and

NBP₄=P(M₄)−P(M′₄)=4−2=2

with M₄={L₁₂, L₂₃, L,₂₄, L₄₅} and P(M₄)=4
M′₄={L₁₂, L,₂₃} and P(M₄)=2,
and

NBP₅=P(M₅)−P(M′₅)=4−3=1

with M₅={L₁₂, L₂₃, L,₂₄, L₄₅} and P(M₅)=4
M′₅={L₁₂, L,₂₃, L₂₄} and P(M₅)=3.

According to the calculated results, node N₂ has the highest node bridging potential NBPᵢ. A higher node bridging potential NBPᵢ relates to a higher impact of the particular node Nᵢ on the network. Such higher impact implicates that the particular node Nᵢ is directly and indirectly linked to a higher number of nodes Nᵢ and/or that the links that the node Nᵢ is directly or indirectly connected with comprise higher linking values vᵢⱼ.

Therefore, a higher node bridging potential NBPᵢ correlates to a higher integration of the particular node Nᵢ in the set of network nodes Nᵢ, Nⱼ. The node bridging potential NBPᵢ preferably affects the node quality score Q_{Ni} of the particular node Nᵢ, i.e. the node quality score of a particular node is a advantageously a function of its node bridging potential.

To assess the impact of a subset Sₖ of nodes Nᵢ on the subset quality score Q_{Sk}, the quality evaluation unit 3 is structured to calculate a source bridging potential SBPₖ of each set Sₖ which is given by the formula (V)

$${SBP}_{k} = {\sum }_{{k}^{′} = 1 , … , s without k} ( P ( {T}_{k} ) - P ( {T}_{{k}^{′}}^{′} ) ) \qquad ( V )$$

In Eq. (V), Tₖ is a set containing all links Lᵢⱼ of the set of links Lᵢⱼ that connect nodes Nⱼ of the set of nodes Nᵢ, Nⱼ directly or indirectly to at least one node Nᵢ in said subset Sₖ. T′_{k′} is a set containing the links of Tₖ without the links Lᵢⱼ directly connected to at least one node Nᵢ in the subset Sₖ and wherein the links Lᵢⱼ of T′_{k′} connect directly or indirectly to nodes Nᵢ of the subset S_{k′}. P is a function of the set X of links Lᵢⱼ given by the formula (IV)

$$P ( X ) = {\sum }_{links {L}_{ij} of the set X} {v}_{ij} . \qquad ( IV )$$

For the present example, with linking values vᵢⱼ [v₁₂, v₂₃, v₂₄, v₄₅]=[1, 1, 1, 1], the source bridging potential SBPₖ for each of the sources S₁, S₂, and S₃ is calculated as following:

For subset S₁, wherein subset S₁={N₁, N₃}:

$$\begin{matrix}{SBP}_{1} = {\sum }_{{k}^{′} = 2 , 3} P ( {T}_{1} ) - P ( {T}_{{k}^{′}}^{′} ) \\ = ( P ( {T}_{1} ) - P ( {T}_{2}^{′} ) ) + ( P ( {T}_{1} ) - P ( {T}_{3}^{′} ) ) \\ = ( 4 - 2 ) + ( 4 - 2 ) \\ = 4\end{matrix}$$

because

T₁={L₁₂,L₂₃,L,₂₄,L₄₅} and P(T₁)=4

and, for k′=2:

T′₂=L,₂₄,L₄₅) and P(T′₂)=2

and, for k′=3:

T′₃=L,₂₄,L₄₅) and P(T′₃)=2.

For subset S₂, wherein subset S₂={N₂}:

$$\begin{matrix}{SBP}_{2} = {\sum }_{{k}^{′} = 1 , 3} P ( {T}_{2} ) - P ( {T}_{{k}^{′}}^{′} ) \\ = ( P ( {T}_{2} ) - P ( {T}_{1}^{′} ) ) + ( P ( {T}_{2} ) - P ( {T}_{3}^{′} ) ) \\ = ( 4 - 0 ) + ( 4 - 1 ) \\ = 7\end{matrix}$$

because

T₂=(L₁₂,L₂₃,L,₂₄,L₄₅) and P(T₂)=4

and, for k′=1:

T′₁={ } and P(T′₁)=0

and for k′=3:

T′₃={L₄₅} and P(T′₃)=1.

For subset S₃, wherein subset S₃={N₄, N₅}:

$$\begin{matrix}{SBP}_{3} = {\sum }_{{k}^{′} = 1 , 2} P ( {T}_{3} ) - P ( {T}_{{k}^{′}}^{′} ) \\ = ( P ( {T}_{3} ) - P ( {T}_{1}^{′} ) ) + ( P ( {T}_{3} ) - P ( {T}_{2}^{′} ) ) \\ = ( 4 - 2 ) + ( 4 - 2 ) \\ = 4\end{matrix}$$

because

T₃={L₁₂,L₂₃,L,₂₄,L₄₅} and P(T₃)=4

and, for k′=1:

T′₁={L₁₂,L₂₃} and P(T′ᵢ)=2

and, for k′=2:

T′₃={L₁₂,L₂₃} and P(T′₃)=2.

In summary, the source bridging potential SBP₂ for subset S₂ results in the highest value for the source bridging potential SBPᵢ. A high source bridging potential refers to a subset Sₖ which is linking a high number of branches of the network and/or to a subset whose direct or indirect links comprise high linking values vᵢⱼ. The calculation of the source bridging potential SBPₖ considers not only the linking values vᵢⱼ of the direct links Lᵢⱼ of the nodes Nᵢ, Nⱼ of the subset Sₖ, but also the linking values vᵢⱼ of the indirect links Lᵢⱼ. Therefore, if the nodes of a subset Sₖ link branches which comprise links with higher linking values, the subset Sₖ can achieve a higher source bridging potential SBP value than if the branches themselves are smaller or comprise fewer links with lower linking values.

The source bridging potential SBP of a subset Sₖ is preferably impacting the quality score of the subs set Sₖ, i.e. the quality score is advantageously a function of the source bridging potential SBP of a subset Sₖ.

The node quality score Q_{Ni} can be calculated for the node Nᵢ using the node seeding potential NSPᵢ or the node bridging potential NBPᵢ, or a combination thereof.

For the subset Sₖ, the subset quality score Q_{Sk} can be calculated from the source seeding potential SSPₖ or the source bridging potential SBPₖ, or a combination thereof.

The following calculation gives an example of a calculation for the node quality score Q_{Ni} of the node Nᵢ as a sum of its node bridging potential and its node seeding potential:

Q_{N1}=NSP₁+NBP₁=4+1=5

Q_{N2}=NSP₂+NBP₂=3+3=6

Q_{N3}=NSP₃+NBP₃=0+1=1

Q_{N4}=NSP₄+NBP₄=1+2=3

Q_{N5}=NSP₅+NBP₅=0+1=1

and for the subset quality score Q_{Sk} of the subset Sₖ we similarly obtain:

Q_{S1}=SSP₁+SBP₁=4+4=8

Q_{S2}=SSP₂+SBP₂=3+7=10

Q_{S3}=SSP₃+SBP₃=1+4=5.

The highest quality score Q_{Ni,max} of the quality scores Q_{Ni} of the nodes Nᵢ is therefore the quality score Q_{N2} for the node N₂. The highest quality score Q_{Sk,max} of the quality scores Q_{Sk} for the subsets Sₖ is therefore the quality score Q_{S2} for the subset S₂.

Since a node with a high quality score Q_{Ni,max} might be particularly interesting for the users of the device, a preferred embodiment of the resource allocation unit 14 allocates more computing units 13, 31 and/or more n bandwidth resources and/or storage resources 11, 32 to node N₂ because it has the highest quality score from all nodes, e.g. by providing more hardware infrastructure for node N₂ in order to enable the users e.g. to receive data from the node N₂ more quickly.

A preferred embodiment of the resource allocation unit 14 would furthermore allocate such more computing units 13, 31 and/or more bandwidth resources and/or storage resources 11, 32 also to the subset S₂ with the highest quality score Q_{S2,max} of all subsets, since such subset S₂ might be particular interesting for the users.

FIG. 2c shows the relation of the subsets to each other. In the present example, all subsets Sₖ are linked with each other, either directly or indirectly. A correspondence of the subsets Sₖ can therefore be evaluated, showing a direct or indirect relationship between subset S₁, S₂, and S₃ form the semantic illustration in the figure.

However, it must be noted that, typically, not all subsets in network 10 will connected (directly and indirectly) to each other.

An example of the application of the device 1 would be the implementation of a scientific database. Scientific measurement results, or other types of observations, e.g. from the field of neuroscience, psychological, pharmaceutical or medical sciences, could be evaluated by the device 1. In particular the device is preferably applicable in scientific fields, where experiments are conducted that collect large amounts of data and where it is difficult to analyze the data for its consistency. The invention therefore provides a device that can collect such data and evaluate it.

The nodes Nᵢ, Nⱼ e.g. contain the experimental data collected in measurements and/or the methods applied in the measurements.

The links between the nodes Lᵢⱼ can e.g. be automatically derived from the content of data of the nodes, e.g. the device could be sensitive to keywords in the data that link the node Nᵢ to a node Nⱼ since both nodes use similar or the same keywords. However, the links can also, at least in part, be entered by the users or by reviewers.

The linking values vᵢⱼ, which are indicative of a correspondence between the nodes Nᵢ, Nⱼ, can e.g. be automatically derived from numerical correlation of the measurement results, from the applied methods for executing the measurement, from an overlap in the references given in the measurement results, or from a similarity of conclusions drawn from the measurement data.

A quality score Q can be calculated for evaluating the measurement results. A measurement result is not only given a quality score according to its own content, but also according to its impact in the whole network.

In addition, the measurement data is also evaluated in respect of its agreement or disagreement with the other measurement data in the network, which agreement or disagreement is expressed in the linking values of the links of the particular node comprising the measurement data.

The linking values can also be dependent on a number of downloads of a node, e.g. by attributing a higher linking value vᵢⱼ for nodes being downloaded more often.

In addition, a further embodiment could also allow the sources or users to control or at least modify the linking values vᵢⱼ, e.g. in a community-based scoring system.

Preferably, the measurement data in the nodes and/or the links between the nodes and/or the linking values thereof and/or the quality score Q of each node and/or each source are published in the public network, such that the users can access this information. For this purpose, the device may comprise a display driver for generating a human-readable representation of this information.

In a further embodiment of the invention, the device can further comprise a data pre-selection unit, which selects measurement data received from the sources according to criteria that could relate to keywords, numbers or methods comprised in the measurement data, and only attributes a node Nᵢ of the set of nodes to the measurement data if this data is in accordance with these criteria. In other words, the entry of new nodes can be reviewed automatically. However, a manual review can be used as well.

In one particular embodiment, the pre-selection unit could e.g. calculate the node quality score Q_{Ni} of a potential new node Nᵢ and use this node quality score as a criterion for entering the new node into the network. I.e., the node is only inserted e.g. if its node quality score Q_{Ni} exceeds a certain threshold.

While there are shown and described presently preferred embodiments of the invention, it is to be distinctly understood that the invention is not limited thereto but may be otherwise variously embodied and practiced within the scope of the following claims. The embodiments presented in the figures are considered to be illustrative and not restrictive.

1. A device for evaluating a quality of measurements, the device comprising
a data store storing
a set of n network nodes Nᵢ, wherein said nodes store measurement data;
a set of l network links Lᵢⱼ, wherein each of the network links Lᵢⱼ connects one network node Nᵢ with at least one network node Nⱼ; and
a quality evaluation unit for calculating said quality, which quality evaluation unit is adapted and structured to calculate a quality score Q as a function of said links Lᵢⱼ.

2. A device for storing and retrieving measurements comprising
a data store storing
a set of n network nodes Nᵢ, wherein said nodes store measurement data;
a set of l network links Lᵢⱼ, wherein each of the network links Lᵢⱼ connects one network node Nᵢ with one network node Nⱼ; and
a quality evaluation unit for calculating a quality score Q as a function of said links Lᵢⱼ,
a resource allocation unit for allocating computing units, bandwidth and/or storage resources for processing the nodes as a function of said quality score Q.

3. Device according to claim 2 connectable to a plurality of computing units,
wherein said resource allocation unit is adapted and structured to allocate a number z of said computing units for processing a given node, wherein said number z depends on the quality score Q.

4. Device according to any claim 2,
wherein the resource allocation unit is adapted and structured to allocate bandwidth resources for processing a given node, wherein said allocated bandwidth resources depend on the quality score Q.

5. Device according to claim 2, wherein said data store comprises a plurality of storage resources, in particular storage resources with different performance,
wherein said resource allocation unit is adapted and structured to select the storage resources for storing each node of the set as a function of said quality score Q.

6. The device according to claim 2,
wherein said data store comprises, for each of said nodes, information indicative of at least one subset Sₖ of nodes that a node belongs to,
and wherein said quality evaluation unit is adapted and structured for calculating a subset quality score Q_{Sk} for at least said subset Sₖ as a function of said links Lᵢⱼ.

7. The device according to claim 1,
wherein said quality evaluation unit is adapted and structured for calculating a node quality score Q_{Ni} for at least one node Nᵢ of said set of nodes as a function of said links Lᵢⱼ.

8. The device according to claim 2,
wherein each link Lᵢⱼ comprises a linking value vᵢⱼ indicative of a correspondence between said nodes Nᵢ and Nⱼ, and
in particular wherein the linking values vᵢⱼ are scalar values.

9. The device according to claim 2,
wherein the linking value vᵢⱼ is larger for a higher correspondence between said nodes Nᵢ and Nⱼ as compared to the linking value vᵢⱼ for a lower correspondence between said nodes Nᵢ and Nⱼ,
wherein, if at least one of said nodes Nᵢ and Nⱼ is in said subset Sₖ, said subset quality score Q_{Sk} increases with an increasing value of said linking value vᵢⱼ,
wherein said resource allocation unit is adapted and structured to allocate an amount of the computing units, the bandwidth or the storage resources for processing said subset Sₖ, which amount is monotonically increasing with said quality score Q_{Sk}.

10. Device according to claim 2,
wherein said network links Lᵢⱼ comprise directional links indicating that a node Nⱼ depends on a node Nᵢ
wherein the quality evaluation unit is structured to calculate said quality score Q as a function of a node seeding potential NSPᵢ of at least one of said nodes Nᵢ, wherein said node seeding potential NSPᵢ of said first node Nᵢ is given by
NSPᵢ=|Cᵢ|

with Cᵢ being a set of nodes containing all nodes Nⱼ depending directly or indirectly on a node Nᵢ and | . . . | being the cardinality of Cᵢ.

11. Device of claim 6,
wherein the quality evaluation unit is structured to calculate said quality score Q as a function of a source seeding potential SSPₖ of said subset Sₖ as a function of
$${SSP}_{k} = {\sum }_{{N}_{i} i n {S}_{k}} {NSP}_{i} .$$

12. Device according to claim 1,
wherein the quality evaluation unit is structured to calculate said quality score Q as a function of a node bridging potential NBPᵢ of at least one node Nᵢ of said nodes, wherein said node bridging potential NBPᵢ is given by
NBPᵢ=P(Mᵢ)−P(M′ᵢ)
with
Mᵢ being a set of links Lₘ containing all links Lᵢⱼ that connect the nodes Nⱼ of the set of nodes directly or indirectly to said node Nᵢⱼ,
M′ᵢ being said set Mᵢ of links Lₘ without the links Lᵢⱼ to said node Nᵢ, and
P being a function of a set X of links given by
$$P ( X ) = {\sum }_{links {L}_{ij} of the set X} {v}_{ij} .$$

13. Device according to claim 6,
wherein the quality evaluation unit is structured to calculate said quality score Q as a function of a source bridging potential SBPₖ of said subset Sₖ of the s subsets Sₖ wherein said source bridging potential SBPₖ is given by
$${SBP}_{k} = {\sum }_{{k}^{′} = 1 , … , s without k} ( P ( {T}_{k} ) - P ( {T}_{{k}^{′}}^{′} ) )$$
with
Tₖ being a set containing all links Lᵢⱼ of the set of links Lᵢⱼ that connect nodes Nᵢ of the set of nodes Nᵢ, Nⱼ directly or indirectly to at least one node Nᵢ in said subset Sₖ; and
T′_{k′} contains the links of said set Tₖ
without the links Lᵢⱼ directly connected to at least one node Nᵢ in said subset Sₖ, and
wherein the links Lᵢⱼ of T′_{k′} connect directly or indirectly to nodes Nᵢ of the subset Sₖ′;
and P being a function of a set X of links given by
$$P ( X ) = {\sum }_{links {L}_{ij} of the set X} {v}_{ij} .$$

14. Device according to claim 10, wherein the quality evaluation unit is structured to calculate the quality score Q as a combination of one or more of the node seeding potential NSP, the source seeding potential SSP, the node bridging potential NBP, and/or the source bridging potential SBP.

15. Device according to claim 1,
wherein the quality evaluation unit is further structured to calculate at least a first quality score Q of a first node or subset and a second quality score Q of a second node or subset, and to evaluate a node or subset Sₘₐₓ with a highest quality score Qₘₐₓ.

16. Device according to claim 6, wherein each one of said subsets Sₖ contains a single node Nᵢ.

17. Device according to claim 6 wherein at least one of said subsets Sₖ contains more than one node Nᵢ.

18. A method for evaluating measurements using the device of claim 1, the method comprising:
storing said measurement data in said nodes Nᵢ, Nⱼ,
storing said links Lᵢⱼ,
calculating said quality score Q for evaluating the quality of said measurement data.

19. Method according to claim 18 further comprising:
executing, by means of several sources, a number of measurements,
storing measurement data from said sources in said nodes Nᵢ, Nⱼ,
storing, for each of said nodes, information indicative of at least one subset Sₖ of nodes that a node belongs to,
with said subsets Sₖ corresponding to said sources Uₖ,
linking said nodes Nᵢ, Nⱼ by said network links Lᵢⱼ.
